(19) United States
(12) Patent Application Publication
(10) Pub. No.: US 2022/0315324 A1
(43) Pub. Date: Oct. 6, 2022

(54) ANNULAR ROTATABLE AIR SUPPLY DEVICE FOR COAL STORAGE EUROSILO

(71) Applicant: HUANENG POWER INTERNATIONAL, INC. SHANGHAI SHIDONGKOU FIRST POWER PLANT, Shanghai (CN)

(72) Inventors: Xiao ZHANG, Shanghai (CN); Xin HU, Shanghai (CN); Ping ZHU, Shanghai (CN)

(21) Appl. No.: 17/447,436

(22) Filed: Sep. 12, 2021

(30) Foreign Application Priority Data
Mar. 31, 2021 (CN) 202110350477.2

(51) Int. Cl. B65D 88/74

(52) U.S. Cl. CPC B65D 88/74

(57) ABSTRACT

Provided is an annular rotatable air supply device for a coal storage Eurosilo. The device includes an air duct rotatable ring and an air duct fixing ring. The air duct rotatable ring is fixedly connected with a central revolving platform of the Eurosilo by a second support bracket, the air duct fixing ring is fixedly connected with a top trestle of the Eurosilo by a first support bracket, and the air duct rotatable ring and the air duct fixing ring are arranged coaxially with the central axis of rotation of the Eurosilo. The air duct air duct rotatable ring is sealingly connected with the air duct fixing ring via a sealing assembly, and the air duct rotatable ring and the air duct fixing ring form an annular air duct therebetween.

### CROSS-REFERENCE TO RELATED APPLICATIONS

This application claims priority benefits to Chinese Patent Application No. 202110350477.2, filed on Mar. 31, 2021. The contents of the aforementioned application are incorporated herein by reference.

### TECHNICAL FIELD

The present disclosure relates to the coal storage technology, and in particular to an annular rotatable air supply device for a coal storage Eurosilo.

### BACKGROUND

Eurosilo coal storage is the latest environmentally friendly coal storage method in China, because the coal types used in foreign Eurosilo storage coal are quite different from those in China, the water content of foreign coal is low, and the evaporation amount of water vapor during coal storage is small. In the actual coal storage process, the water vapor concentration in the Eurosilo is low, which will not affect the environment in the Eurosilo. However, the coal type used in China is mainly lignite, which has a high proportion of powdery particles, large in volatile matter and water, and is easy to spontaneously ignite. Therefore, a higher water vapor concentration will be produced in the Eurosilo where coal is stored, and water vapor with a higher concentration will condense into water droplets when it encounters the equipment in the Eurosilo and the metal structure of the Eurosilo body, after the water droplets are combined with the gas released from various coals in the Eurosilo, various acidic corrosive substances are produced. When the acidic corrosive substances adhere to the surfaces of metal parts in the Eurosilo, they will cause corrosion damage to these metal equipment, and then bring extremely adverse effects. In addition, at present, the coal widely used in domestic power generation enterprises has high volatile matter content and a large volatile amount, and more methane and carbon monoxide are emitted from coal during coal storage. These combustible gases gather in the Eurosilo and can easily cause various fires or endanger the personal safety of maintenance and operation personnel entering the Eurosilo. To prevent spontaneous ignition of coal, the domestic power generation enterprises generally use nitrogen to prevent the oxidation reaction of coal, a large amount of nitrogen is released from the bottom of the Eurosilo, so that nitrogen can fill the gaps among coal particles to isolate the oxygen around the coal, thus avoiding or reducing the possibility of oxidation reaction of coal. However, in this way, it is inevitable that some nitrogen will penetrate from the coal accumulated in the Eurosilo, and is dispersed into the space where coal is not piled in the Eurosilo, this will also reduce the oxygen content in the space where coal is not piled in the Eurosilo, when personnel need to enter the Eurosilo for equipment maintenance or operation, there is a risk of suffocation due to the low oxygen concentration. Except for the conventional positive pressure respirator, most of the other kinds of mouth masks can not effectively ensure the normal breathing of the personnel. However, after wearing the positive pressure respirator, the personnel are inconvenient to move and the normal operation requirements can not be satisfied.

Although an exhaust fan is arranged on the top of the Eurosilo, the actual exhaust effect is not good, mainly because all kinds of gases and water vapor are mainly gathered near the accumulated coal, that is, near the upper surface of the coal pile in the Eurosilo. However, the exhaust fan on the top of the Eurosilo mainly discharges the gas near the exhaust fan, and the Eurosilo is not a sealed container, at many structural junctions of the Eurosilo, for example, between the top of the Eurosilo and the barrel, there are always various gaps, so that gas can enter the Eurosilo, then the gas flows to the exhaust fan and is discharged by the exhaust fan. Because the flow of gas always occurs from the place where the resistance is the least, while the gas near the coal pile in the Eurosilo flows relatively slowly, especially in the Eurosilo, the height of coal pile is low, that is, under the condition of less stored coal, when the distance between the surface of the coal pile and the exhaust fan is far, the top fan of the Eurosilo has poor ability to absorb the gas near the surface of the coal pile, and as a result, it takes at least 10 hours to replace the gas in the barrel cleanly, In addition, if the amount of exhaust of the exhaust fan is greater than the amount of air entering from the gap, only negative pressure will be formed in the Eurosilo and causes an unnecessary load to the top of the Eurosilo, but can not effectively make the gas near the coal pile flow to the position near the top of the Eurosilo, ineffective ventilation will seriously restrict the timeliness of operation in the Eurosilo of the personnel, or bring hidden dangers to the safety of coal storage in the Eurosilo, which seriously affects the normal coal storage production and operation of the Eurosilo.

### SUMMARY

The disclosure aims at overcoming the defects of the prior art and provides an annular rotatable air supply device for a coal storage Eurosilo, which has good sealing performance, high air supply efficiency, and small occupied space, does not affect the original structure and operation process of the Eurosilo, and meets the air supply demand at the revolving trestle.

The objective of the present disclosure can be achieved by the following technical solution:

An annular rotatable air supply device for a coal storage Eurosilo, including an air duct rotatable ring and an air duct fixing ring;

The air duct rotatable ring is fixedly connected with a central revolving platform of the Eurosilo by a second support bracket, the air duct fixing ring is fixedly connected with a top trestle of the Eurosilo by a first support bracket, the air duct rotatable ring and the air duct fixing ring are arranged coaxially with the central axis of rotation of the Eurosilo;

The air duct rotatable ring is sealingly connected with the air duct fixing ring via a sealing assembly, the air duct rotatable ring and the air duct fixing ring form an annular air duct therebetween;

An air inlet duct communicating with the annular air duct is arranged on the air duct fixing ring, an end of the air inlet duct is connected with an air supply fan outside the Eurosilo, and an air outlet duct communicating with the annular air duct is arranged on the air duct rotatable ring; and

when the air supply device is in operation, the air duct fixing ring is fixed in position, the air duct rotatable ring rotates synchronously with the central revolving platform, and fresh and dry air outside the Eurosilo successively passes through the air supply fan, the air inlet duct, the annular air duct and the air outlet duct and is discharged to the vicinity of the central revolving platform of the Eurosilo and quickly blows away the wet, toxic and harmful gas near the revolving trestle, so as to meet the anti-corrosion requirements of metal parts in the Eurosilo, and at the same time meet the air supply demand at the revolving trestle, and ensure the personal safety of operators here.

Further, the air duct fixing ring includes a cylinder and a third annular plate, the cylinder are provided with two fourth annular plates symmetrically arranged on the two ends thereof respectively, each of the fourth annular plates is provided with an eighth annular plate perpendicularly arranged on the edge thereof, and the third annular plate is fixedly connected with the eighth annular plate; and

the air duct rotatable ring includes an annular groove, the opening direction of the annular groove horizontally faces the central axis direction of the annular groove, and a side wall of the annular groove is connected with the third annular plate by a sealing assembly.

Further, the annular groove is provided with a second annular plate perpendicularly arranged on the side wall thereof, the second annular plate is provided with a first annular plate parallel thereto; and

the sealing assembly includes a sealing band and an annular hooklike plate, the sealing band adopts a non-metallic material which is wear-resistant, flexible and elastically stretchable, one end of the sealing band is fixed on the first annular plate via a collar, and the other end is closely attached to the annular hooklike plate, and the annular hooklike plate is fixedly connected with the third annular plate.

Further, the annular hooklike plate is provided with a fifth annular plate along the horizontal direction, the third annular plate is provided with a sixth annular plate along the horizontal direction, and the fifth annular plate is connected with the sixth annular plate via a third bolt in the vertical direction;

The annular hooklike plate is provided with a waist-shaped hole in the vertical direction, the third annular plate is connected with the annular hooklike plate by a fourth bolt passing through the waist-shaped hole, and the height of the annular hooklike plate is adjustable by adjusting the position of the fourth bolt passing through the waist-shaped hole. The third bolt and the fourth bolt jointly realize position fixing of the annular hooklike plate, and the structure is stable.

Further, the annular hooklike plate is provided with an incline, and the sealing band is closely attached to the incline. When the annular hooklike plate moves upwards, the larger the contact area between the end of an extended section of the sealing band and the incline is, the larger the diameter of the end of the extended section is, the sealing band is stretched, so that the end of the extended section and the incline are more closely fit, and the sealing performance of the annular air duct is ensured.

Further, the diameter of the collar is greater than that of an outer sidewall of the first annular plate, and the first annular plate is provided with a flange, and the sealing band covers the flange. The part of the sealing band covering the flange is stretched, so that the sealing band can be tightly hooped on the flange, and at the same time, the end of the extended section of the sealing band can be stretched by the stretching action of the flange on the sealing band, and the stretching amount is less than the stretching amount of the sealing band at the flange, so that the end of the extended section of the sealing band can always keep a circle similar to the annular flange.

Further, an adjustment screw is arranged between the second annular plate and the first annular plate, the adjustment screw is provided with a nut, and the spacing between the first annular plate and the second annular plate is adjustable by rotating the nut on the adjustment screw. A reinforcing rib plate is arranged between the annular groove and the second annular plate, the second annular plate is always perpendicular to the side wall of the annular groove, so that the position of the first annular plate can be adjusted by the adjustment screw, so that the circular tolerance of the annular flange is within a set range, the operation is flexible, the tension degree of the sealing band can be flexibly adjusted, and the sealing band is convenient to disassemble and assemble.

Further, an O-ring seal is arranged between the annular hooklike plate and the third annular plate, so that the gap between contact faces of the third annular plate and the annular hooklike plate is closed, and the sealing effect is good.

Compared to the prior art, the present disclosure has the following advantageous effects:

(1) When the air supply device provided by the disclosure is operated, the air duct fixing ring is fixed in position, the air duct rotatable ring rotates synchronously with the central revolving platform, the fresh and dry air outside the Eurosilo successively passes through the air supply fan, the air inlet duct, the annular air duct, and the air outlet duct, and is discharged to the vicinity of the central revolving platform of the Eurosilo to rapidly blow off wet, toxic and harmful gases near the central revolving platform to meet a requirement for corrosion protection of metal components in the Eurosilo and also satisfy the demand for wind supply at the revolving trestle, thus safeguarding the human safety of operators. The air outlet duct rotates synchronously so that the air exhausted from the air outlet duct can spread evenly so that the wet, toxic and harmful gases near the central revolving platform are sufficiently spread out to meet the requirement for corrosion protection of the metal components in the Eurosilo and also satisfy the demand for wind supply at the revolving trestle, thus safeguarding the human safety of operators;

(2) The air supply device provided by the disclosure is annular in its entirety, and disposed coaxially with a revolving center shaft of the revolving trestle, the characteristics of the structure of equipment within the Eurosilo can be fully utilized, without the need to change the original structure of the Eurosilo and without interference with the structure of the revolving trestle, so that the operation of the Eurosilo is not affected, and there is little impact on the servicing of the Eurosilo. Besides, the resistance experienced by the air supply device is small and the air supply efficiency is high;

(3) The annular hooklike plate is provided with a waist-shaped hole in the vertical direction, the third annular plate is connected with the annular hooklike plate by a fourth bolt passing through the waist-shaped hole, and the height of the annular hooklike plate is adjustable by adjusting the position of the fourth bolt passing through the waist-shaped hole. The annular hooklike plate is provided with an incline, and the sealing band is closely fit to the incline. When the annular hooklike plate moves upwards, the larger the contact area between the end of an extended section of the sealing band and the incline is, the larger the diameter of the end of the extended section is, the sealing band is stretched, so that the end of the extended section and the incline are more closely fit, and the sealing performance of the annular air duct is ensured. Therefore, the height of the annular hooklike plate can be adjustable to improve the tightness between the sealing band and the incline, and the operation is flexible. When the air duct rotatable ring rotates, the sealing band rotates synchronously, and its position may move down. At this time, the contact area between the end of the extended section of the sealing band and the incline becomes larger, the sealing performance is not affected, and the sealing performance and stability of the annular air duct are good;

(4) The air pressure delivered in the annular air duct of the present disclosure is greater than the air pressure outside the annular air duct, the annular air duct is a positive pressure air duct, the sealing band is able to fit more tightly on the incline under the action of air pressure to achieve the sealing effect, and with an increase in air pressure within the annular air duct, the fit is closer. When the end of the extended section of the sealing band has a certain length, the concentricity of the air duct rotatable ring, the air duct fixing ring (22) and the sealing band has a certain deviation, or when the roundness of the annular hooklike plate has a certain deviation, a better sealing effect can still be generated, and the sealing performance and stability of the annular air duct are good;

(5) A fifth annular plate in the horizontal direction is arranged on the annular hooklike plate of the present disclosure, a sixth annular plate in the horizontal direction is arranged on the third annular plate, the fifth annular plate is connected with the sixth annular plate by a third bolt in the vertical direction, the third bolt and the fourth bolt jointly achieve positional fixing of the annular hooklike plate, and the structure is stable;

(6) The collar of the disclosure has a diameter greater than the diameter of the outer sidewall of the first annular plate, the first annular plate is provided with a flange, the sealing band covers the flange, the portion of the sealing band covering the flange is stretched, so that the sealing band can be tightly hooped on the flange; and

(7) An adjustment screw is arranged between the second annular plate and the first annular plate, the adjustment screw is provided with a nut, and the spacing between the first annular plate and the second annular plate is adjustable by rotating the nut on the adjustment screw. A reinforcing rib plate is arranged between the annular groove and the second annular plate, the second annular plate is always perpendicular to the side wall of the annular groove, so that the position of the first annular plate can be adjusted by the adjustment screw, so that the circular tolerance of the annular flange is within the set range, the operation is flexible, the tension degree of the sealing band can be flexibly adjusted, and the sealing band is convenient to disassemble and assemble.

### BRIEF DESCRIPTION OF THE DRAWINGS

FIG. 1 is a structural schematic diagram of an existing Eurosilo.

FIG. 2 is a structural schematic diagram of the present disclosure.

FIG. 3 is an assembly schematic diagram of an air duct fixing ring and a sealing assembly.

FIG. 4 is a structural schematic diagram of an air duct rotating ring.

FIG. 5 is a structural schematic diagram of a collar.

FIG. 6 is a cross-sectional view of the sealing assembly.

FIG. 7 is a schematic perspective view of the sealing assembly.

FIG. 8 is a schematic diagram of the installation position of an annular rotary air supply device on an Eurosilo.

FIG. 9 is a structural schematic diagram of an air duct fixing ring.

FIG. 10 is a schematic diagram of the mounting position of an O-ring seal.

Description for symbols in the accompanying drawings:

1. barrel, 2. feed inlet, 3. top trestle, 4. revolving trestle, 5. walking mechanism, 6. central telescopic discharge pipe, 7. lifting wire rope, 8. spiral frame, 9. screw machine, 10. dust cover of guide chute, 11. A-type frame, 12. center hoisting platform, 13. central revolving platform, 15. air inlet duct, 16. air supply fan, 17. air outlet duct, 18. first support bracket, 19. second support bracket, 20. first bolt, 21. air duct rotating ring, 22. air duct fixing ring, 23. second bolt, 24. collar, 25. third bolt, 26. sealing band, 27. fourth bolt, 28. O-ring seal, 29. annular hooklike plate, 30. reinforcing rib plate, 31. waist-shaped hole, 32. adjustment screw, 211. first annular plate, 212. annular groove, 213. second annular plate, 221. third annular plate, 222. end plate, 223. cylinder, 261. end of extended section, 291. annular hooklike plate, 292. fourth annular plate, 293. fifth annular plate, 2111. flange, 2211. sixth annular plate.

### DETAILED DESCRIPTION

The present disclosure will now be described in detail with reference to the accompanying drawings and specific embodiments. While the present embodiments are carried out in light of the present technical solution, detailed implementation modes and specific operating procedures are given, the scope of protection of the present disclosure is not limited to the embodiments described below.

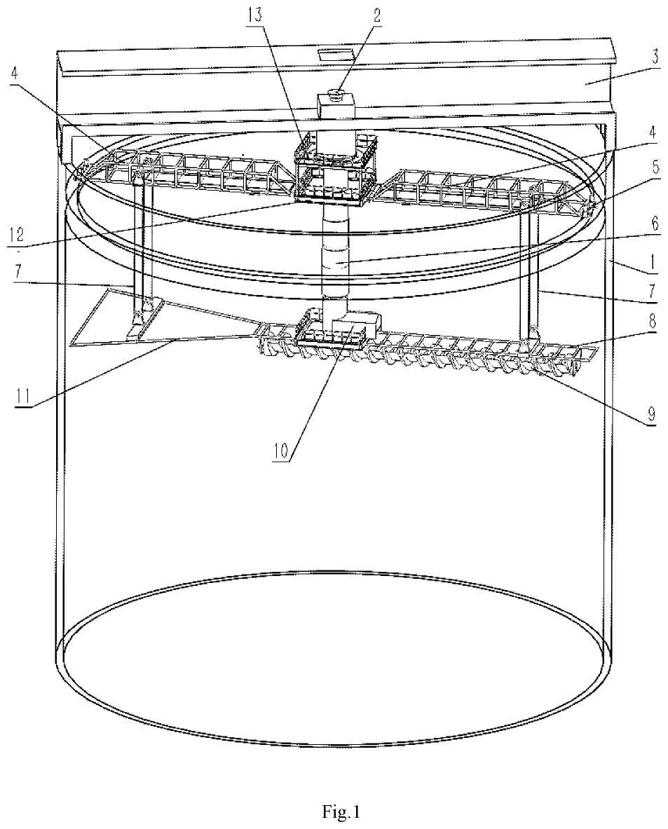

As in FIG. 1, the top of a barrel 1 of an Eurosilo is provided with a top trestle 3, a belt conveyor is arranged within the top trestle 3, a revolving trestle 4, a central telescopic discharge pipe 6, a spiral frame 8 and an A-type frame 11 are arranged in the barrel 1, the spiral frame 8 and the A-type frame 11 are hung on the revolving trestle 4 by the lifting wire rope 7 and a hoisting machine, the spiral frame 8 and the A-type frame 11 are connected. A screw machine 9 is arranged on the spiral frame 8, the revolving trestle 4 is arranged on an annular track on the inner side wall of the barrel 1 by a walking mechanism 5, the center of the revolving trestle 4 is provided with a center hoisting platform 12, the central telescopic discharge pipe 6 is coaxial with the barrel 1, and passes through the central hoisting platform 12, the upper end of the central telescoping discharge pipe 6 is aligned with a feed inlet 2 on the top trestle 3, the lower end is connected with the screw machine 9 through a guide chute, and a dust cover of the guide chute 10 is arranged on the guide chute, the coal is conveyed by the belt conveyor at the feed inlet to the feed inlet 2 and then is conveyed to the screw machine 9 by the central telescopic discharge pipe 6, the coal falls from a discharge port of the screw machine 9 into the barrel 1. The screw machine 9 rotates with the rotation of the revolving trestle 4, and simultaneously does lifting movement by the lifting wire rope 7 to make the coal stored uniformly within the barrel 1. The central telescopic discharge pipe 6 is concentrically connected by several segments of circular tubes of different diameters, the two ends of each segment of circular tube are provided with steps of different diameters, such that two adjacent sections of circular tubes are hooked to each other and slide relatively along the axial direction of the circular tube, the several sections of the circular tubes are joined along one axis, the sections of the circular tubes are expanded or contracted section by section as the distance between the two ends of the central telescopic discharge pipe 6 is extended or shortened, so that the distance between the two ends of the central telescopic discharge pipe 6 can vary depending on the distance between the revolving trestle 4 and the spiral frame 8.

Due to the interference between various pipes or devices fixed for air supply on the outside of the Eurosilo and the rotating structure of the revolving trestle 4 in the Eurosilo, the traditional air supply device cannot meet this requirement.

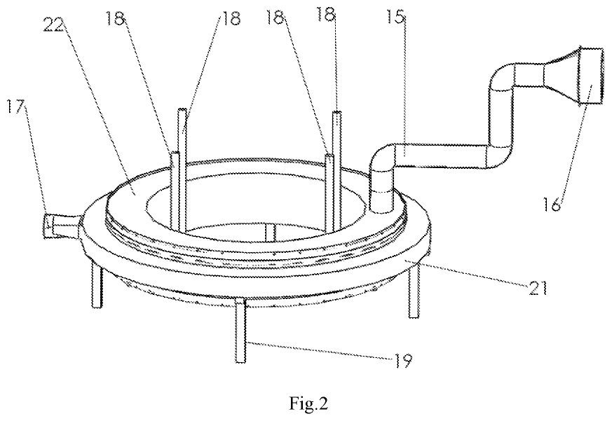

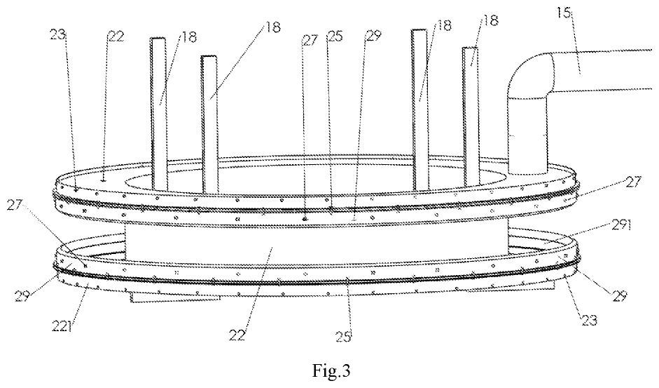

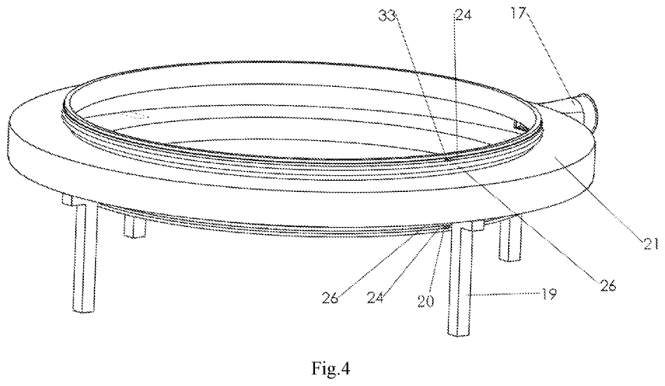

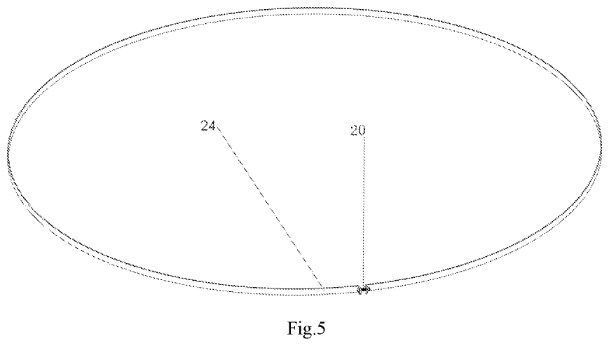

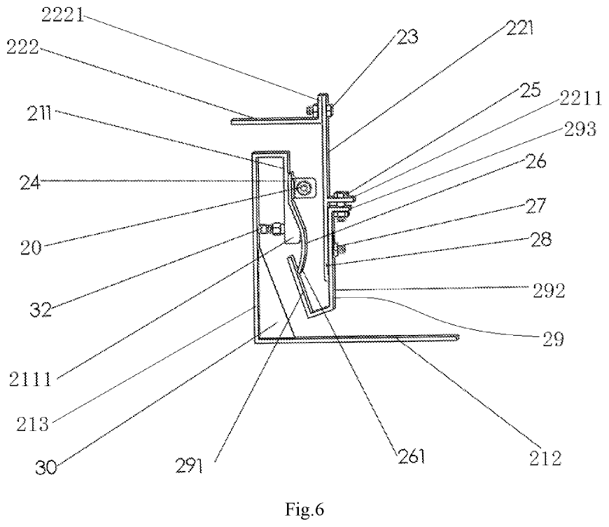

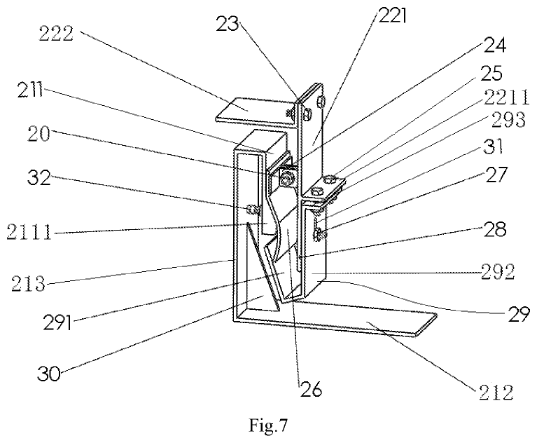

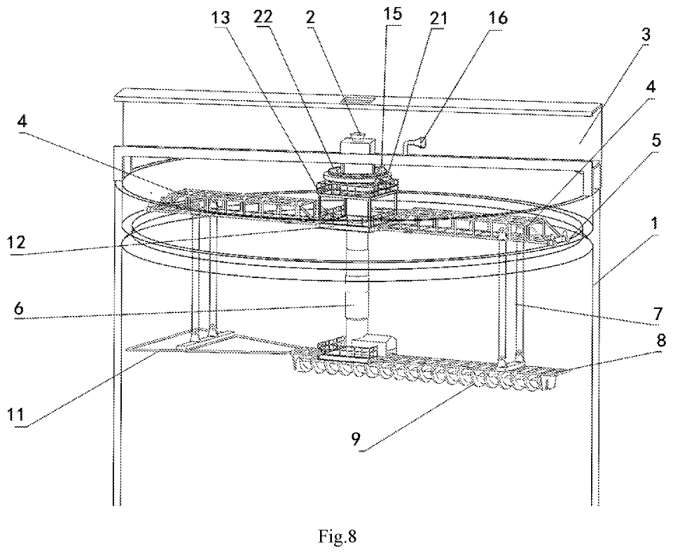

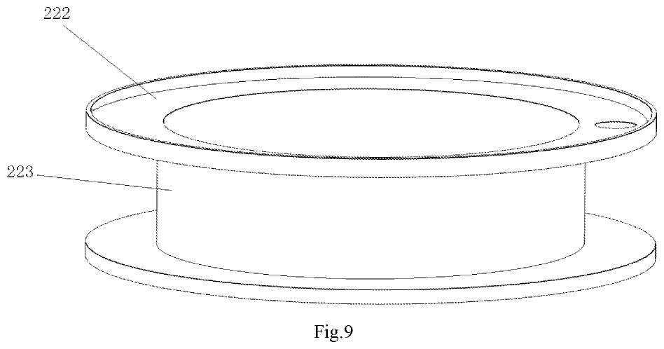

An annular rotary air supply device for a coal storage Eurosilo, as shown in FIGS. 2, 3, 4, 5, 6, 7, 8, 9 and 10, includes an air duct rotating ring 21 and an air duct fixing ring 22;

The air duct rotating ring 21 is fixedly connected with the central revolving platform 13 by the second support bracket 19, and rotates with rotation of the revolving trestle 4, the air duct fixing ring 22 is fixedly connected with the top trestle 3 by a first support bracket 18, the position is kept fixed, the air duct rotating ring 21 and the air duct fixing ring 22 are arranged coaxially with the central axis of rotation of the Eurosilo, the central axis of rotation of the Eurosilo refers to the axis of the barrel 1, and is the central axis of rotation of the revolving trestle 4, the central revolving platform 13 and the spiral frame 8, and also the central axis of the central telescopic discharge pipe 6.

The air duct fixing ring 22 includes a cylinder 223 vertically arranged. The cylinder 223 are provided with two fourth annular plates 222 symmetrically arranged on the two ends thereof respectively, and each of the fourth annular plates 222 is provided with an eighth annular plate 2221 perpendicularly arranged on the edge thereof.

The air duct rotating ring 21 includes an annular groove 212, the opening of which is oriented horizontally towards the central axis of the annular groove 212, the two side walls of the annular groove 212 are sealingly connected with the fourth annular plate 222 respectively by sealing assemblies, the cylinder 223, the fourth annular plate 222 and the annular groove 212 form a closed annular air duct thereamong.

An air outlet duct 17 communicating with the annular air duct is horizontally arranged on the air duct rotating ring 21, an air inlet duct 15 communicating with the annular air duct is arranged on the air duct fixing ring 22, and an air supply fan 16 is arranged at the end of the air inlet duct 15, the air inlet duct 15 and the air supply fan 16 are fixed on the top trestle 3 or the top of the Eurosilo.

The air duct fixing ring 22 further includes a third annular plate 221, the sealing assembly includes a sealing band 26 and an annular hooklike plate 29, the sealing band 26 is a non-metallic material that is wear resistant, flexible, and elastically stretchable, the annular groove 212 is provided with a second annular plate 213 perpendicularly arranged on the side wall thereof, the second annular plate 213 is provided with a first annular plate 211 parallel thereto, the annular hooklike plate 29 is provided with an incline 291 and a fifth annular plate 292, one end of the sealing band 26 is fixed to the first annular plate 211 by the collar 24, and the other end, i.e. the end of the extend section 261, is closely fit to the incline 291, the end of the collar 24 is connected by a first bolt 20, the third annular plate 221 is fixedly connected by a second bolt 23 with an eighth annular plate 2221, the third annular plate 221 is perpendicularly provided with a sixth annular plate 2211, and the sixth annular plate 2211 is fixedly connected by a third bolt 25 with a fifth annular plate 292.

A waist-shaped hole 31 in the vertical direction is arranged on the annular hooklike plate 29, the third annular plate 221 is fixedly connected with the annular hooklike plate 29 by a fourth bolt 27 passing through the waist-shaped hole 31, the height of the annular hooklike plate 29 can be adjustable by adjusting the position of the fourth bolt 27 passing through the waist-shaped hole 31, as the annular hooklike plate 29 moves upwards, the larger the contact area of the end of the extended section 261 of the sealing band 26 with the incline 291 is, the larger the diameter of the end of the extended section 261 is, the sealing band is stretched, so that the end of the extended section 261 and the incline 291 are more closely fit, and the sealing performance of the annular air duct is ensured;

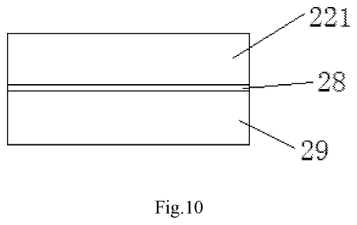

As shown in FIG. 10, an O-ring seal 28 is arranged between the third annular plate 221 and the annular hooklike plate 29, so that the gap between the contact faces of the third annular plate 221 and the annular hooklike plate 29 is closed and good sealing effect is achieved.

The end of the first annular plate 211 is provided with a flange 2111, the diameter of the collar 24 is larger than the diameter of the outer side wall of the first annular plate 211, and since the maximum diameter of the flange 2111 is larger than the diameter of the outer side wall of the first annular plate 211, the portion of the sealing band 26 that covers the flange 2111 is stretched, thus enabling the sealing band 26 to be tightly hooped on the flange 2111;

An adjustment screw 32 is arranged between the first annular plate 211 and the second annular plate 213, a nut is arranged on the adjustment screw 32, a reinforcing rib plate 30 is arranged between the second annular plate 213 and the side wall of the annular groove 212, thus ensuring that the second annular plate 213 is always perpendicular to the side wall of the annular groove 212. Since the sealing band 26 is hooked on the first annular plate 211 by the collar 24, the position of the first annular plate 211 can be adjustable by adjusting the spacing between the first annular plate 211 and the second annular plate 213 by rotating the nut on the adjusting screw 32, so that the circular tolerance of the flange 2111 is smaller than or equal to 5 mm.

The pressure of air delivered within the annular air duct is greater than the pressure of air outside the annular duct, the annular air duct is a positive pressure air duct, the sealing band 26 is able to fit more tightly against the incline 291 under the action of air pressure to achieve the sealing effect, a certain deviation of the concentricity of the air duct rotating ring 21, the air duct fixing ring 22 and the sealing band 26 exists due to the length of the end of extended section 261 of the sealing band 26, or a certain deviation of the circularity of the annular hooklike plate 29 exists, but a good sealing effect can still be generated.

When the revolving trestle 4 rotates, the annular hooklike plates 29 rotate synchronously, thus creating a slippage phenomenon between the sealing band 26 which is always stationary and the incline 291, the end of extended section 261 of the sealing band 26 is always fit closely with the incline 291 under the tightening force generated by the stretched sealing band 26 and the air pressure inside the annular air duct, and the fit is closer as the air pressure rises inside the annular air duct.

The fresh and dry air outside the Eurosilo enters the annular air duct through the air supply fan 16 and air inlet duct 15, the duct air duct rotating ring 21 rotates with rotation of the revolving trestle 4, the air within the annular air duct is exhausted through the air outlet duct 17 to the vicinity of the central revolving platform 13 and quickly blow off the wet, toxic and harmful gases near the central revolving platform 13 so as to meet the anti-corrosion requirements of metal parts in the Eurosilo, and at the same time meet the air supply demand at the revolving trestle, thus ensuring the personal safety of operators here.

The present embodiment presents an annular rotary air supply device for a coal storage Eurosilo, which can solve the problems that occurs when the Eurosilo stores coal with large volatile matter and high moisture content and needs to release nitrogen to prevent spontaneous combustion or oxidation, and improves the adaptability of the Eurosilo to store various types of coal.

Preferred embodiments of the disclosure are described in detail above. It should be understood that numerous modifications and variations can be made in accordance with the inventive concepts by those of ordinary skill in the art without creative effort. Therefore, any technical solution that can be obtained by logical analysis, reasoning or limited experiments based on the prior art according to the idea of the present invention should be within the scope of protection determined by the claims.

We claim:

1. An annular rotatable air supply device for a coal storage Eurosilo, comprising an air duct rotatable ring (21) and an air duct fixing ring (22); wherein
the air duct rotatable ring (21) is fixedly connected with a central revolving platform (13) of the Eurosilo by a second support bracket (19), the air duct fixing ring (22) is fixedly connected with a top trestle (3) of the Eurosilo by a first support bracket (18), the air duct rotatable ring (21) and the air duct fixing ring (22) are arranged coaxially with the central axis of rotation of the Eurosilo;
the air duct air duct rotatable ring (21) is sealingly connected with the air duct fixing ring (22) via a sealing assembly, the air duct rotatable ring (21) and the air duct fixing ring (22) form an annular air duct therebetween;
an air inlet duct (15) communicating with the annular air duct is arranged on the air duct fixing ring (22), an end of the air inlet duct (15) is connected with an air supply fan (16) outside the Eurosilo, and an air outlet duct (17) communicating with the annular air duct is arranged on the air duct rotatable ring (21); and
when the air supply device is in operation, the air duct fixing ring (22) is fixed in position, the air duct rotatable ring (21) rotates synchronously with the central revolving platform (13), and air outside the Eurosilo successively passes through the air supply fan (16), the air inlet duct (15), the annular air duct and the air outlet duct (17) and is discharged to the vicinity of the central revolving platform (13) of the Eurosilo.

2. The annular rotatable air supply device for a coal storage Eurosilo of claim 1, wherein the air duct fixing ring (22) comprises a cylinder (223) and a third annular plate (221), the cylinder (223) are provided with two fourth annular plates (222) symmetrically arranged on the two ends thereof respectively, each of the fourth annular plates (222) is provided with an eighth annular plate (2221) perpendicularly arranged on the edge thereof, and the third annular plate (221) is fixedly connected with the eighth annular plate (2221); and
the air duct rotatable ring (21) comprises an annular groove (212), and a side wall of the annular groove (212) is connected with the third annular plate (221) by a sealing assembly.

3. The annular rotatable air supply device for a coal storage Eurosilo of claim 2, wherein the annular groove (212) is provided with a second annular plate (213) perpendicularly arranged on the side wall thereof, the second annular plate (213) is provided with a first annular plate (211) parallel thereto; and
the sealing assembly comprises a sealing band (26) and an annular hooklike plate (29), one end of the sealing band (26) is fixed on the first annular plate (211) via a collar (24), and the other end is closely attached to the annular hooklike plate (29), and the annular hooklike plate (29) is fixedly connected with the third annular plate (221).

4. The annular rotatable air supply device for a coal storage Eurosilo of claim 3, wherein the annular hooklike plate (29) is provided with an incline (291), and the sealing band (26) is closely attached to the incline (291).

5. The annular rotatable air supply device for a coal storage Eurosilo of claim 3, wherein the first annular plate (211) is provided with a flange (2111), and the sealing band (26) covers the flange (2111).

6. The annular rotatable air supply device for a coal storage Eurosilo of claim 3, wherein the annular hooklike plate (29) is provided with a waist-shaped hole (31) in the vertical direction, the third annular plate (221) is connected with the annular hooklike plate (29) by a fourth bolt (27) passing through the waist-shaped hole (31), and the height of the annular hooklike plate (29) is adjustable by adjusting the position of the fourth bolt (27) passing through the waist-shaped hole (31).

7. The annular rotatable air supply device for a coal storage Eurosilo of claim 3, wherein a fifth annular plate (292) is arranged on the annular hooklike plate (29) and a sixth annular plate (2211) is arranged on the third annular plate (221), and the fifth annular plate (292) is connected with the sixth annular plate (2211) by a third bolt (25).

8. The annular rotatable air supply device for a coal storage Eurosilo of claim 3, wherein an adjustment screw (32) is arranged between the second annular plate (213) and the first annular plate (211), the adjustment screw (32) is provided with a nut, and the spacing between the first annular plate (211) and the second annular plate (213) is adjustable by rotating the nut on the adjustment screw (32).

9. The annular rotatable air supply device for a coal storage Eurosilo of claim 8, wherein a reinforcing rib plate (30) is arranged between the annular groove (212) and the second annular plate (213).

10. The annular rotatable air supply device for a coal storage Eurosilo of claim 3, wherein an O-ring seal (28) is arranged between the annular hooklike plate (29) and the third annular plate (221).
